(19) United States
(12) Patent Application Publication
(10) Pub. No.: US 2026/0275851 A1
(43) Pub. Date: Sep. 17, 2026

(54) METHOD FOR LEACHING ROCK METAL COMPONENT, METHOD FOR STORING CARBON DIOXIDE UNDERGROUND, AND METHOD FOR FIXING CARBON DIOXIDE

(71) Applicant: TOHOKU UNIVERSITY, Sendai-shi, Miyagi (JP)

(72) Inventors: Noriaki WATANABE, Sendai-shi (JP); Jiajie WANG, Sendai-shi (JP); Atsushi OKAMOTO, Sendai-shi (JP); Ryota SEKIAI, Sendai-shi (JP)

(73) Assignee: TOHOKU UNIVERSITY, Sendai-shi, Miyagi (JP)

(21) Appl. No.: 19/168,177

(22) PCT Filed: Sep. 11, 2023
(86) PCT No.: PCT/JP2023/033026

§ 371 Date: Sep. 23, 2025

(30) Foreign Application Priority Data
Mar. 28, 2023 (JP) 2023-051335

(51) Int. Cl. E21B 43/28; C09K 8/72; C22B 3/16; E21B 41/00

(52) U.S. Cl. CPC E21B 43/28; C09K 8/72; C22B 3/165; E21B 41/0064

(57) ABSTRACT

A method for leaching rock metal components, capable of enhancing dissolution of mafic rocks such as basalt and ultramafic rocks such as olivine at lower than 200° C. underground and improving permeability of the rocks, a method for storing carbon dioxide underground using the above method, and a method for fixing carbon dioxide. The method includes a leaching fluid composed of a chelating agent-containing liquid is injected into mafic rocks or ultramafic rocks at lower than 200° C. underground to extract, into the leaching fluid, metal components included in the mafic rocks or ultramafic rocks. Furthermore, carbon dioxide or a storage liquid with carbon dioxide dissolved therein is injected into the mafic rocks or ultramafic rocks from which the metal components have been extracted into the leaching fluid.

### FIELD OF THE INVENTION

The present invention relates to a method for leaching rock metal components, a method for storing carbon dioxide underground, and a method for fixing carbon dioxide.

### DESCRIPTION OF RELATED ART

As methods for reducing carbon dioxide (CO₂) emitted into the atmosphere, methods of storing carbon dioxide in underground basaltic reservoirs, and methods of further chemically reacting carbon dioxide with metal components such as Ca, Mg, and Fe in the basaltic reservoirs and then fixing carbon dioxide through carbonate mineralization (mineral fixation), have been attracting worldwide attention in recent years. For example, in Iceland, a Carbfix (CCS) project has already been implemented, where water with carbon dioxide dissolved therein is stored in basaltic reservoirs (e.g., see Non-Patent Literature 1). It has been reported that, within two years, carbon dioxide is reacted with metal components such as Ca eluted from basalt and fixed to minerals (e.g., see Non-Patent Literature 2).

In these methods, for efficiently storing and fixing a larger amount of carbon dioxide in basaltic reservoirs, it is necessary to increase a porosity and pore connectivity of basalt to improve the permeability of basalt, or to increase an elution rate of metal components such as Ca from basalt.

Conventionally, the present inventors and other researchers have developed methods for improving permeability of rocks, where a weakly acidic to weakly alkaline chelating agent aqueous solution is injected into volcanic rocks such as granite or basalt at 200° C., conditions suitable for geothermal power generation (e.g., see Non-Patent Literatures 3 and 4). It has been confirmed that this method enhances the dissolution of granite and volcanic rocks, and pores are formed to improve permeability of the rocks.

### CITATION LIST

### Non-Patent Literature

Non-Patent Literature 1: Carbfix, [online], [Accessed on Mar. 7, 2023], website [URL: https://www.carbfix.com]
Non-Patent Literature 2: Sandra O. Snaebjornsdottir et al., “Carbon dioxide storage through mineral carbonation”, Nature Reviews Earth & Environment, 2020, 1, p. 90-102
Non-Patent Literature 3: Ryota Takahashi, Jiajie Wang, Noriaki Watanabe, “Process and optimum pH for permeability enhancement of fractured granite through selective mineral dissolution by chelating agent flooding”, Geothermics, 2023, 109, 102646
Non-Patent Literature 4: Luis Salala, Ryota Takahashi, Jonathan Argueta, Jiajie Wang, Noriaki Watanabe, Noriyoshi Tsuchiya, “Permeability enhancement and void formation by chelating agent in volcanic rocks (Ahuachapan and Berlin geothermal fields, El Salvador)”, Geothermics, 2023, 107, 102586

### SUMMARY OF THE INVENTION

### Problem to be Solved

The methods described in Non-Patent Literatures 3 and 4 make it possible to enhance dissolution of granite and volcanic rocks at 200° C. and improve permeability of the rocks. However, the methods described in Non-Patent Literatures 3 and 4 have not been applied to mafic rocks such as basalt and ultramafic rocks such as olivine at other temperatures, particularly lower than 200° C. suitable for carbon dioxide storage. Moreover, it is impossible to predict a temperature dependency of dissolution rates of the rocks composed of various types of minerals. Thus, it is unclear what effects would arise if the methods described in Non-Patent Literatures 3 and 4 are applied to mafic rocks such as basalt and ultramafic rocks such as olivine at lower than 200° C. Up until today, no experiments or reports, whether based on these methods described in Non-Patent Literatures 3 and 4 or not, have used a chelating agent aqueous solution for mafic rocks such as basalt and ultramafic rocks such as olivine at lower than 200° C.

The present invention has been embodied with a focus on the above problems, and the objective is to provide a method for leaching rock metal components, capable of enhancing dissolution of mafic rocks such as basalt and ultramafic rocks such as olivine at lower than 200° C. underground and improving permeability of the rocks, a method for storing carbon dioxide underground using the above method, and a method for fixing carbon dioxide.

### Solution to Problem

To achieve the above object, the method for leaching the rock metal components according to the present invention is characterized in that a leaching fluid composed of a chelating agent-containing liquid is injected into mafic rocks or ultramafic rocks at lower than 200° C. underground to extract, into the leaching fluid, metal components included in the mafic rocks or ultramafic rocks.

In the method for leaching rock metal components according to the present invention, metal components such as Ca, Mg, and Fe included in mafic rocks or ultramafic rocks underground are dissolved in a leaching fluid composed of a chelating agent-containing liquid, and therefore can be extracted into the leaching fluid. This makes it possible to enhance dissolution of mafic rocks or ultramafic rocks underground. Furthermore, as mafic rocks and ultramafic rocks underground are dissolved, resulting in forming pores in the rocks, so that the porosity and pore connectivity can be increased and the permeability of the rocks can be improved.

In the method for leaching the rock metal components according to the present invention, carbon dioxide or a liquid in which carbon dioxide is dissolved, can be injected into the formed and interconnected pores to store carbon dioxide in the pores. Furthermore, the metal components such as Ca, Mg, and Fe extracted into the leaching fluid can be chemically reacted with carbon dioxide to produce carbonate minerals and to fix carbon dioxide to the minerals.

In the method for leaching the rock metal components according to the present invention, it is preferable that, when injecting the leaching fluid, a well is dug from the surface to the mafic rock layer or ultramafic rock layer underground and the leaching fluid is injected into the mafic rock or ultramafic rock underground through the well. Furthermore, the leaching fluid into which the metal components have been extracted may be left underground, for example, to allow the metal components to react with carbon dioxide underground. Alternatively, for example, the leaching fluid may be recovered at the surface for the purpose such as reacting the metal components with carbon dioxide above the ground or hollowing the pores.

In the method for leaching the rock metal components according to the present invention, as the mafic rocks and ultramafic rocks, for example, rocks with a high porosity, such as basalt and olivine found at relatively shallow underground or on the seafloor, can be used. The porosity and the pore connectivity of the rocks can be increased to improve their permeability. Particularly preferably, the mafic rocks or ultramafic rocks underground are at a temperature of 100° C. or lower.

In the method for leaching the rock metal components according to the present invention, the chelating agent is preferably a biodegradable chelating agent or a thermally decomposable chelating agent. In this case, after the metal components such as Ca, Mg, and Fe are extracted from the mafic rocks or ultramafic rocks underground, the chelating agent in the leaching fluid is biodegraded or thermally decomposed to release the metal components. Thus, for example, when carbon dioxide or a liquid in which carbon dioxide is dissolved therein is injected into the formed pores or interconnected pores, the released metal components, such as Ca, Mg, and Fe, can chemically react with carbon dioxide, and mineral fixation of carbon dioxide can be enhanced. Furthermore, since the chelating agent is biodegradable or thermally decomposable, the method is environmentally friendly. The biodegradable chelating agent may be any agent, for example, such as N,N-Bis(carboxymethyl)-L-glutamic acid (GLDA). It is preferable that the thermally decomposable chelating agent can be decomposed in geothermal environments.

In the method for leaching the rock metal component according to the present invention, pH of the leaching fluid may be any value within the range of 1 to 14. For example, if the leaching fluid is acidic, it has a particularly high effect of enhancing dissolution of mafic rocks and ultramafic rocks underground, and particularly the permeability of the rocks can be effectively increased.

In the method for leaching the rock metal components according to the present invention, the leaching fluid may consist of a liquid containing both the chelating agent and carbon dioxide. In this case, for example, by adding carbon dioxide to an alkaline chelating agent, the leaching fluid can be adjusted to a desired pH. Furthermore, simply by injecting the leaching fluid into the mafic rocks and ultramafic rocks, carbon dioxide can be stored in the pores of the rocks enhanced dissolution by the chelating agent underground, or carbon dioxide can be fixed to minerals through the chemical reaction between carbon dioxide and the metal components such as Ca, Mg, and Fe extracted from the mafic rocks and ultramafic rocks.

The method for storing carbon dioxide underground according to the present invention is characterized in that carbon dioxide or a storage liquid with carbon dioxide dissolved therein is injected into the mafic rocks or ultramafic rocks from which the metal components have been extracted into the leaching fluid, by the method for leaching the rock metal components according to the present invention.

In the method for storing carbon dioxide underground according to the present invention, pores are formed by the method for leaching the rock metal components according to the present invention, and a storage liquid is injected into mafic rocks or ultramafic rocks with a permeability enhanced by increasing the porosity and the pore connectivity underground, so that carbon dioxide can be stored in the pores of the rocks. Furthermore, the metal components such as Ca, Mg, and Fe extracted into the leaching fluid can chemically react with the stored carbon dioxide to form carbonate minerals, thereby carbon dioxide can be fixed to minerals in the pores.

When applying the method for storing carbon dioxide underground according to the present invention, injecting carbon dioxide has the advantage of storing a larger amount of carbon dioxide compared to the injecting of the storage liquid. On the other hand, injecting of the storage liquid has an advantage of enhancing mineral fixation of carbon dioxide compared to the injecting carbon dioxide because the chemical reaction between the metal components and carbon dioxide occurs in the storage liquid.

When injecting the storage liquid in the method for storing carbon dioxide underground according to the present invention, the pH of the storage liquid may be any value within the range of 1 to 14. For example, if the leaching fluid is alkaline, it has a high effect of enhancing the chemical reaction between the metal components and carbon dioxide, thereby particularly promoting mineral fixation of carbon dioxide.

In the method for storing carbon dioxide underground according to the present invention, it is preferable that the storage liquid contains a chelating agent. In this case, the storage liquid has a high effect of enhancing dissolution of mafic rocks and ultramafic rocks underground, and/or enhancing the storage and mineral fixation of carbon dioxide. In particular, it is preferable that the chelating agent contained in the storage liquid is either biodegradable chelating agent or thermally decomposable chelating agent. In this case, since the chelating agent is biodegradable or thermally decomposable, the method is environmentally friendly. The biodegradable chelating agent may be any agent, for example, N,N-Bis(carboxymethyl)-L-glutamic acid (GLDA). It is preferable that the thermally decomposable chelating agent can be geothermally decomposed.

The method for fixing carbon dioxide according to the present invention is characterized in that the leaching fluid into which the metal components have been extracted by the method for leaching the rock metal components according to the present invention is recovered, and the metal components contained in the recovered leaching fluid are chemically reacted with carbon dioxide to produce carbonate minerals.

In the method for fixing carbon dioxide according to the present invention, carbon dioxide can be fixed to minerals at the recovery site such as the ground surface, by chemically reacting carbon dioxide with the metal components such as Ca, Mg, and Fe contained in the recovered leaching fluid to produce carbonate minerals. Since the permeability of the mafic rocks and ultramafic rocks underground after the recovery of the leaching fluid has been improved by the increased porosity and pore connectivity, more carbon dioxide can be stored in the pores compared to before the injection of the leaching fluid, by injecting carbon dioxide or a liquid with dissolved carbon dioxide.

### Effects of Invention

The present invention makes it possible to provide a method for leaching rock metal components, capable of enhancing dissolution of mafic rocks such as basalt and ultramafic rocks such as olivine at lower than 200° C. underground and improving the permeability of the rocks, a method for storing carbon dioxide underground using the above method, and a method for fixing carbon dioxide.

### BRIEF DESCRIPTION OF THE DRAWINGS

FIG. 1 is a horizontal sectional view of a basaltic reservoir underground, illustrating a method for leaching rock metal components and a method for storing carbon dioxide underground according to an embodiment of the present invention.

FIG. 2 is a sectional view illustrating an experimental apparatus for use in an experiment for dissolving basalt with a leaching fluid in the method for leaching rock metal components according to the embodiment of the present invention.

FIG. 3 presents graphs indicating (a) a temporal change in a pressure difference between both end faces of a sample (Differential press; pressure on upstream end face−pressure on downstream end face) in a case that the leaching fluid is adjusted to pH 8 with nitric acid, (b) a temporal change in a concentration of each element contained in elution, (c) a temporal change in a pressure difference between the both end faces of the sample in a case that the leaching fluid is adjusted to pH 6 with nitric acid, (d) a temporal change in a concentration of each element contained in elution, (e) a temporal change in a pressure difference between the both end faces of the sample in a case that the leaching fluid is adjusted to pH 4 with nitric acid, and (f) a temporal change in a concentration of each element contained in elution, in the experiment using the experimental apparatus illustrated in FIG. 2 in the method for leaching rock metal components according to the embodiment of the present invention.

FIG. 4 presents X-ray CT images indicating a volume distribution of unconnected pores in the sample (a) before and (b) after the experiment using the experimental apparatus illustrated in FIG. 2, in the method for leaching rock metal components according to the embodiment of the present invention.

FIG. 5 presents graphs indicating a temporal change in a concentration (Concentration) of each element contained in elution in (a) a case that the leaching fluid is adjusted to pH 8 with nitric acid, (b) a case that the leaching fluid is adjusted to pH 8 with carbon dioxide, and (c) a comparative example using a liquid adjusted to pH 4 by dissolving carbon dioxide in pure water, in the experiment using the experimental apparatus illustrated in FIG. 2 in the method for leaching rock metal components according to the embodiment of the present invention.

FIG. 6 presents graphs indicating a concentration (Concentration) of each element contained in the leaching fluid after reaction at a reaction temperature of (a) 22° C., (b) 50° C., or (c) 100° C. in an experiment for investigating a temperature dependency of a dissolution effect with the leaching fluid in the method for leaching rock metal components according to the embodiment of the present invention.

### DETAILED DESCRIPTION OF THE INVENTION

The embodiment of the present invention will be explained below based on Figures, Examples, and the like.

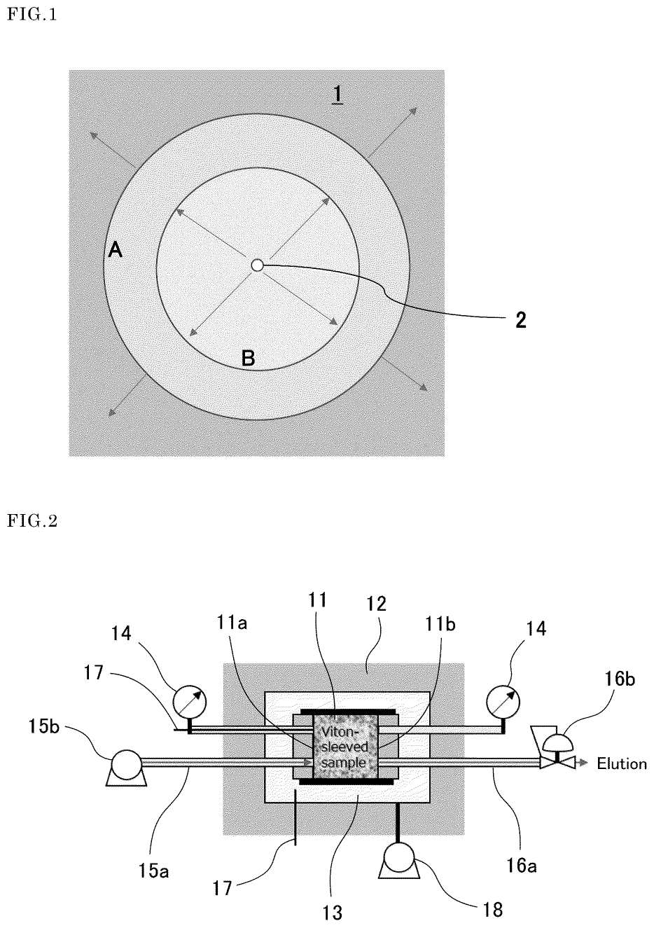

FIGS. 1 to 6 present the method for leaching rock metal components, the method for storing carbon dioxide underground, and the method for fixing carbon dioxide, according to the embodiment of the present invention.

As illustrated in FIG. 1, in the method for leaching rock metal components and the method for storing carbon dioxide underground according to the embodiment of the present invention, first, a well 2 is dug from the soil surface to a basaltic reservoirs 1 underground, and a leaching fluid is injected into the basaltic reservoirs 1 underground using the well 2 by the method for leaching rock metal components according to the embodiment of the present invention. The leaching fluid is composed of a chelating agent-containing liquid.

Once the leaching fluid is injected, the leaching fluid dissolves metal components such as Ca, Mg, and Fe contained in the basaltic reservoirs 1 underground, and thereby these metal components can be extracted into the leaching fluid. This enhances the dissolution of the basaltic reservoirs 1 underground. Furthermore, the dissolution of the basaltic reservoirs 1 results in the formation of pores in the basaltic reservoirs 1, so that the porosity and the pore connectivity can be increased, and the permeability of the basaltic reservoirs 1 can be improved.

Although the rock for the leaching fluid to be injected thereinto is basalt in FIG. 1, the rock may also be a mafic rock other than basalt or an ultramafic rock, and is preferably, for example, a relatively porous rock such as basalt or olivine at lower than 200° C. found at relatively shallow underground locations or on the seafloor. It is preferable that the chelating agent in the leaching fluid is composed of a biodegradable chelating agent and adjusted to have a strong acidity to weak acidity of pH 1 to 6 with a pH adjuster such as nitric acid. This makes it possible to improve an effect of enhancing the dissolution of basalt and effectively improve the permeability of basalt. Furthermore, the chelating agent is environmentally friendly as it degrades underground.

Subsequently, the metal components contained in the basaltic reservoirs 1 underground are extracted into the leaching fluid, then carbon dioxide or a storage liquid with carbon dioxide dissolved therein is injected into the basaltic reservoirs 1 using the previously dug well 2 by the method for storing carbon dioxide underground according to the embodiment of the present invention. At this time, the porosity and pore connectivity of the basaltic reservoirs 1 are increased by the leaching fluid to improve the permeability, and thereby carbon dioxide can be stored in the pores. The metal components such as Ca, Mg, and Fe extracted into the leaching fluid can chemically react with the stored carbon dioxide to produce carbonate minerals, and thereby carbon dioxide can be fixed to the minerals in the pores.

Furthermore, by injecting carbon dioxide into the basaltic reservoirs 1, a larger amount of carbon dioxide can be stored compared to the case of injecting the storage liquid. Also, by injecting the storage liquid into the basaltic reservoirs 1, the chemical reaction between the metal components in the leaching fluid and carbon dioxide and the mineral fixation of carbon dioxide can be enhanced compared to the case of injecting only carbon dioxide. When using the storage liquid, it is preferable that the storage liquid contains carbon dioxide and is composed of a liquid containing a biodegradable chelating agent adjusted to have a weak alkalinity to strong alkalinity of pH 8 to 14. Thereby, the chemical reaction between the metal components and carbon dioxide and the mineral fixation of carbon dioxide can be further enhanced. Furthermore, since the chelating agent is biodegradable underground, the storage liquid is environment-friendly.

Furthermore, in the case that the chelating agent in the leaching fluid is composed of a biodegradable chelating agent, after the metal components such as Ca, Mg, and Fe are extracted from basalt, the chelating agent are biodegraded to release the metal components, and therefore, subsequently carbon dioxide or the storage liquid can be injected into the pores of basalt to further enhance the chemical reaction between the released metal components such as Ca, Mg, and Fe and carbon dioxide, and to further enhance the mineral fixation of carbon dioxide.

In the example illustrated in FIG. 1, by injecting the leaching fluid from the well 2, the leaching fluid can permeate to the position A to increase the porosity and pore connectivity of the basaltic reservoirs 1 and to improve the permeability. Further, by injecting carbon dioxide or the storage liquid from the well 2, carbon dioxide or the storage liquid can permeate to the position B to store carbon dioxide in the pores of the basaltic reservoirs 1. When the permeability of the basaltic reservoirs 1 is significantly improved by the leaching fluid, the position B comes closer to the position A, and, in some cases, overlaps with the position A.

The chelating agents in the leaching fluid and the storage liquid may be composed of a thermally decomposable material. Also in this case, the chelating agent can enhance the mineral fixation of carbon dioxide and is environment-friendly, like the biodegradable chelating agent.

The chelating agent in the leaching fluid may be adjusted to have a weak acidity to weak alkalinity (about pH 4 to 10) with carbon dioxide. In this case, simply by injecting the leaching fluid, carbon dioxide can be stored in the pores of the basaltic reservoirs 1 with a dissolution enhanced by the chelating agent, and carbon dioxide can be chemically reacted with the metal components such as Ca, Mg, and Fe extracted from the basaltic reservoirs 1 to fix carbon dioxide to the minerals. When the chelating agent is adjusted to be weakly acidic (about pH 4 to 6) with carbon dioxide, the effect of enhancing dissolution of the basaltic reservoirs 1 can be improved to significantly improve the permeability, and carbon dioxide can be stored in the pores of the basaltic reservoirs 1. Also, when the chelating agent is adjusted to be weakly alkaline (about pH 8 to 10) with carbon dioxide, the permeability of the basaltic reservoirs 1 can be increased but not to the extent in the case of weak acidity, and the mineral fixation of carbon dioxide injected into the pores of the basaltic reservoirs 1 can be further enhanced. As described above, in both cases, since carbon dioxide can be stored or fixed to minerals simply by injecting the leaching fluid, carbon dioxide or the storage liquid may be or may not be additionally injected into the basaltic reservoirs 1 after the injection of the leaching fluid.

Furthermore, carbon dioxide may be fixed to minerals by the following process: after the metal components contained in the basaltic reservoirs 1 underground are extracted into the leaching fluid by the method for leaching the rock metal components according to the embodiment of the present invention, the leaching fluid is recovered from a well different from the previously dug well 2 by the method for fixing carbon dioxide according the embodiment of the present invention, and carbonate minerals are produced by chemically reacting carbon dioxide with the metal components such as Ca, Mg, and Fe contained in the recovered leaching fluid. In this case, carbon dioxide can be fixed to the minerals at the place where the leaching fluid is recovered, such as the soil surface. Note that, since the permeability of the basaltic reservoirs 1 after the recovery of the leaching fluid has been improved because of the increased porosity and pore connectivity, carbon dioxide or a liquid with carbon dioxide dissolved therein can be injected into the pores to store a larger amount of carbon dioxide compared to before the injection of the leaching fluid. In the example illustrated in FIG. 1, the well for recovering the leaching fluid should be located inside the position A to which the leaching fluid permeates.

### Example 1

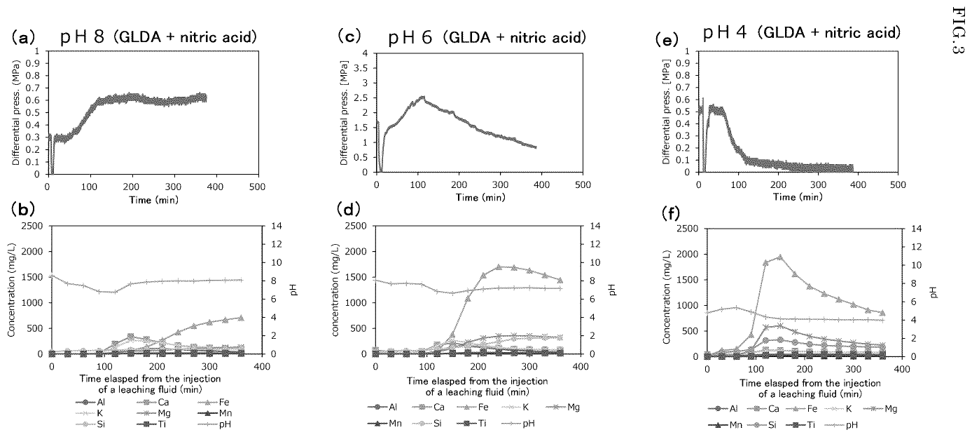

To evaluate the method for leaching the rock metal components according to the embodiment of the present invention, an experiment for dissolving basalt with a leaching fluid was conducted. In the experiment, the apparatus illustrated in FIG. 2 was used. In the experiment, a pH-adjusted 20 wt %-concentration GLDA-Na₄ aqueous solution was used as the leaching fluid. This leaching fluid is an aqueous solution containing L-glutamate diacetate (GLDA) which is a biodegradable chelating agent, and the GLDA-Na₄ aqueous solution has a strong alkalinity of pH 11 or higher. As a basalt sample 11, a porous olivine-basalt sampled in Daikon-jima Island, Shimane Prefecture was used. The contents of the minerals and the like contained in this sample 11 are presented in Table 1. As illustrated in FIG. 2, a rock formed into a columnar shape with a diameter of 25 mm and a height of 25 mm was used as the sample 11 (Viton-sleeved sample).

TABLE 1

| Minerals etc. | Content (vol %) |
|---|---|
| Anorthite: CaAl₂Si₂O₈ | 47.25 |
| Augite: (Ca, Mg, Fe)₂Si₂O₆ | 34.00 |
| Forsterite: Mg₂SiO₄ | 6.00 |
| Glassy substance | 10.00 |
| Opaque mineral | 2.75 |

As illustrated in FIG. 2, in the experiment, the sample 11 is placed inside a pressure vessel 12 with a central axis of the sample 11 aligned horizontal, and an inside space of the pressure vessel 12 is filled with a silicone oil 13. Pressure sensors 14 are attached to both the left and right end faces 11a and 11b of the sample 11 to measure the pressures at each end faces 11a and 11b. A feed pipe 15a and a feed pump 15b are provided for supplying the liquid to one end face (upstream end face) 11a of the sample 11, and a discharge pipe 16a and an adjustment valve 16b are provided for discharging the liquid from the other end face (downstream end face) 11b of the sample 11. Thermocouples 17 are installed for measuring a temperature of the one end face 11a of the sample 11 and an internal temperature of the pressure vessel 12, respectively. A silicone oil pump 18 is provided for adjusting an internal pressure of the pressure vessel 12. A heating/heat-retaining device (not illustrated) is provided for allowing the pressure vessel 12 to be heated from the outside.

In the experiment, the internal temperature of the pressure vessel 12 was maintained at 100° C. using the heating/heat-retaining device, and the internal pressure of the pressure vessel 12 was maintained at 6 MPa using the silicone oil pump 18. Under these conditions, pure water was first fed to the sample 11 at a flow rate of 0.1 mL/min through the feed pipe 15a using the feed pump 15b, and then discharged from the discharge pipe 16a to allow pure water to flow through the sample 11. In this discharge of pure water, the discharge pressure (back pressure) on the other end face 11b of the sample 11 was adjusted to 1 MPa using the adjustment valve 16b. After the flow rate and back pressure were stabilized, pure water was replaced with the leaching fluid, and the leaching fluid was allowed to flow through the sample 11 at the same flow rate and back pressure for 6 hours. In the experiment, while allowing pure water and the leaching fluid to flow, the pressures at both end faces 11a and 11b of the sample 11 were measured using the pressure sensor 14. Elution was sampled at the time of replacing pure water with the leaching fluid and subsequently every 30 minutes, and the concentration of each element contained in elution was measured.

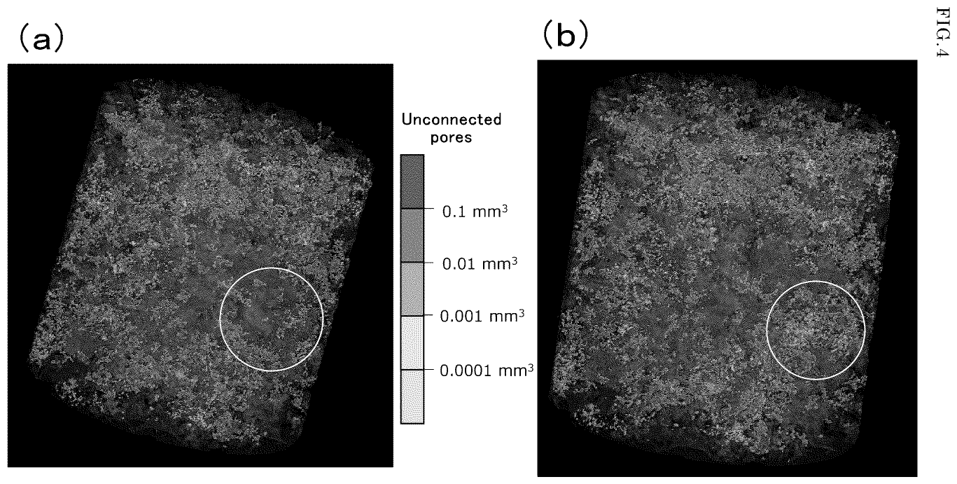

The experimental results with the leaching fluid adjusted to pH 8, 6, and 4 using nitric acid are presented in FIG. 3. FIGS. 3 (a), (c), and (e) present a temporal change in a differential press between the upstream end face 11a and the downstream end face 11b of the sample 11 at pH 8, 6, or 4 respectively. FIGS. 3 (b), (d), and (f) present a temporal change in the concentration of each element and in pH of elution. Note that, in FIGS. 3(a), (c), and (e), the time point at around 0 minute when the pressure difference temporarily drops to zero and then returns to around the original pressure difference refers to the time point when pure water was replaced to the leaching fluid.

As presented in FIG. 3 (a), it was found that, at pH 8, when pure water was replaced with the leaching fluid, initially the pressure difference gradually increased because of the higher viscosity of the leaching fluid in comparison with pure water, but after about 100 minutes, the pressure difference became almost constant. The constant pressure difference suggests that the permeability of the sample 11 was almost constant. As presented in FIG. 3 (c), it was found that, at pH 6, when pure water was replaced with the leaching fluid, initially the pressure difference gradually increased as in FIG. 3 (a), but after about 100 minutes, the pressure difference gradually decreased. The pressure difference decreasing to about one-third suggests that the permeability of the sample 11 increased about three times compared to the case of pH 8 in FIG. 3 (a). As presented in FIG. 3 (e), at pH 4, no increase in the pressure difference similar to that in FIGS. 3 (a) and (c) was observed, and the pressure difference was confirmed to significantly decrease in about 100 minutes. Based on the decrement of the pressure difference, it is considered that the permeability of the sample 11 increased 11 times or more compared to the case of pH 8 in FIG. 3 (a).

As presented in FIG. 3 (b), it was found that, at pH 8, Fe, Ca, and K were primarily extracted into elution. As presented in FIG. 3 (d), it was found that, at pH 6, in addition to Fe, Ca, and K, Mg and Si were also extracted into elution. Furthermore, it was found that, at pH 6, a larger amount of Fe was extracted compared to the case of pH 8 in FIG. 3 (b). As presented in FIG. 3 (f), it was found that, at pH 4, Fe, Mg, and Si were primarily extracted into elution, and although in a small amount, Ca was also extracted. Also, it was found that, at pH 4, a larger amount of Mg was extracted compared to the case of pH 6 in FIG. 3 (d). As described above, it was found that elements such as Ca, Mg, and Fe capable of reacting with carbon dioxide to produce carbonate minerals were extracted by the leaching fluid at pH 4 to 8. Also, it was found that, the lower the pH, the shorter the time required for each element to be extracted.

From the results presented in FIG. 3, it is considered that, the lower the pH, the higher the dissolution rate of minerals of the leaching fluid, and the higher the effect of enhancing the dissolution of basalt. Also, it is considered that, the lower the pH, the higher the effect of improving the permeability of basalt. From this, it is considered that, as the pH of the leaching fluid is lower, the injection pressure can be reduced and the injection time can be shortened when injecting carbon dioxide or the storage liquid into basalt with increased permeability, and thereby the energy required for the injection can be reduced and the safety of the injection process can be improved.

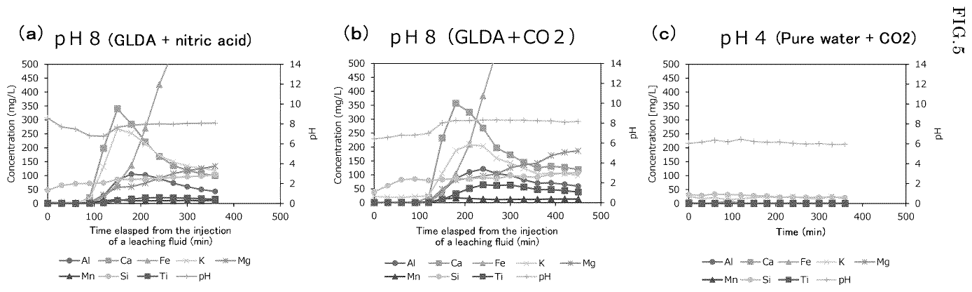

Subsequently, three-dimensional spatial distributions of the sample 11 before and after the experiment at pH 6 were determined by an X-ray computed tomography (X-ray CT) method. From the determined three-dimensional spatial distributions, unconnected pores in the sample 11 were extracted and classified by volume, and the results are presented in FIG. 4. Comparing FIG. 4 (a) before the experiment and FIG. 4 (b) after the experiment, it was found that the volume of the unconnected pores decreased after the experiment, for example, as indicated by the circled areas in the figures.

When determining the total porosity from the three-dimensional spatial distributions obtained by the X-ray CT method, the total porosity was 18.2% before the experiment but 18.4% after the experiment, indicating that the pores increased by 0.2%. When determining a proportion of the unconnected pores to the total pores, the proportion was 17.6% before the experiment but 12.2% after the experiment, indicating that the unconnected pores decreased by 5.4%. From these results, the proportion of connected pores that are not unconnected pores is 15.0% [=18.2%×(100%−17.6%)] before the experiment and 16.2% [=18.4%×(100%−12.2%)] after the experiment. This indicates that the volume of the connected pores increased by 8% [=(16.2%/15.00)−1] by allowing the chelating agent-containing leaching fluid to flow through the sample for 6 hours.

The results of the X-ray CT method indicated that the chelating agent-containing leaching fluid made it possible to increase the porosity and the pore connectivity in a relatively short time (6 hours). Consequently, it is possible to increase the carbon dioxide storage space into which carbon dioxide or the storage liquid is injected.

### Example 2

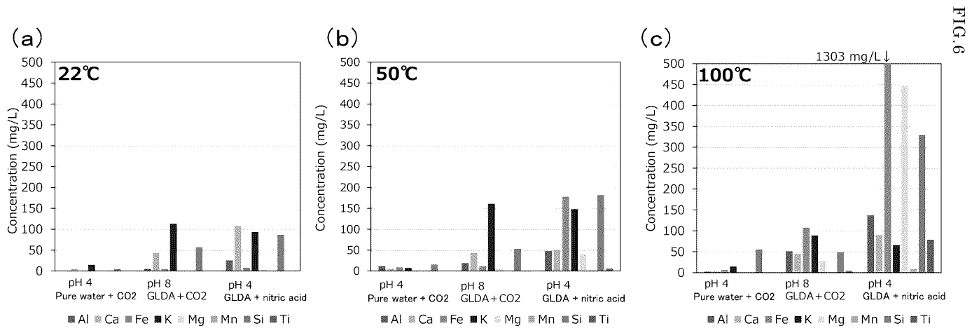

A basalt dissolution experiment with the experimental apparatus illustrated in FIG. 2 was conducted in the same manner as in Example 1, using, as the leaching fluid, a 20 wt %-concentration GLDA-Na₄ aqueous solution adjusted to pH 8 with carbon dioxide. As a comparative example, the same experiment was conducted except that a liquid adjusted to pH 4 by dissolving carbon dioxide in pure water was used instead of the leaching fluid. The liquid used in this comparative example corresponds to the storage liquid used in the conventional storage method described in Non-Patent Document 1. The results of these experiments are presented in FIGS. 5 (b) and (c) respectively. For comparison, the experimental result in Example 1 with the leaching fluid adjusted to pH 8 with nitric acid is presented in FIG. 5 (a). In FIG. 5 (a), the ordinate scales of the concentration (Concentration) of each element in FIG. 3 (b) are matched with those of FIGS. 5 (b) and (c).

As presented in FIG. 5 (b), it was found that even if the leaching fluid was a weakly alkaline liquid containing carbon dioxide, the leaching fluid dissolved the minerals in basalt to elute each metal element. Also, it was found that, the extraction rates and extracted volumes of Ca, Mg, and Fe in FIG. 5 (b) were slightly higher than those in FIG. 5 (a). Also, it was found that the extraction rates and extracted volumes of each element in FIG. 5 (b) were higher than those in the comparative example in FIG. 5 (c).

From these results, it can be concluded that, by using a chelating agent-containing leaching fluid allowed to absorb carbon dioxide and adjusted to be weakly alkaline, elements such as Ca, Mg, and Fe can be extracted, and the metal elements can chemically react with carbon dioxide contained in the leaching fluid to enhance the mineral fixation of carbon dioxide. Furthermore, it can be concluded that, by allowing the alkaline chelating agent-containing leaching fluid to absorb carbon dioxide, the carbon dioxide content per unit volume can be increased compared to the conventional leaching fluids prepared by dissolving carbon dioxide in pure water as in the comparative example in FIG. 5 (c), and thereby the mineral fixation rate of carbon dioxide can be increased.

### Example 3

An experiment for investigating the temperature dependency of the dissolution effect of the leaching fluid was conducted. In the experiment, first, 2.5 g of basalt powder and 50 mL of the leaching fluid were put into a reaction vessel, and the vessel was sealed. The inside of the reaction vessel was pressurized to 1 MPa with nitrogen gas, and reacted while maintaining the temperature at 22° C., 50° C., and 100° C. for one hour. Subsequently, the leaching fluid was removed from the reaction vessel, and the concentrations of each element contained therein were measured.

In the experiment, a 20 wt %-concentration GLDA-Na₄ aqueous solution adjusted to pH 8 with carbon dioxide and a 20 wt %-concentration GLDA-Na₄ aqueous solution adjusted to pH 4 with nitric acid were used as the leaching fluids. As a comparative example, the same experiment was conducted except that a liquid adjusted to pH 4 by dissolving carbon dioxide in pure water was used instead of the leaching fluid. The experimental results at each reaction temperature are presented in FIGS. 6 (a) to (c).

As presented in FIGS. 6 (a) to (c), in the comparative examples, the element extraction concentrations (Concentration) were low regardless of the reaction temperature even if the leaching fluid had an acidity of pH 4, and in contrast, when using the chelating agent-containing leaching fluid, each metal element was extracted even at 100° C. or lower or even with a weakly alkaline leaching fluid, indicating the high mineral dissolution effect. In particular, as presented in FIG. 6 (a), elements such as Ca could be extracted even at room temperature, indicating that the mineral dissolution effect was higher than that in the comparative example. Furthermore, there was a tendency that, when using the chelating agent-containing leaching fluid, the higher the reaction temperature, the higher the concentrations of each extracted metal element, indicating that the high reaction temperature improved the mineral dissolution effect.

### REFERENCE SIGNS LIST

1 Basaltic reservoirs
2 Well
11 Sample
   11a (One or Upstream) end face
   11b (The other or Downstream) end face
12 Pressure vessel
13 Silicone oil
14 Pressure sensor
15a Feed pipe
15b Feed pump
16a Discharge pipe
16b Adjustment valve
17 Thermocouple
18 Silicone oil pump

1. A method for leaching a rock metal component, wherein a leaching fluid composed of a chelating agent-containing liquid is injected into a mafic rock or ultramafic rock at lower than 200° C. underground to extract, into the leaching fluid, a metal component contained in the mafic rock or ultramafic rock.

2. The method according to claim 1, wherein the chelating agent is composed of a biodegradable chelating agent or a thermally decomposable chelating agent.

3. The method according to claim 1, wherein the leaching fluid is acidic.

4. The method according to claim 1, wherein the leaching fluid is composed of a liquid containing the chelating agent and carbon dioxide.

5. The method according to claim 1, wherein the leaching fluid is injected into basalt or olivine as the mafic rock or the ultramafic rock underground.

6. A method for storing carbon dioxide underground, wherein carbon dioxide or a storage liquid with carbon dioxide dissolved therein is injected into the mafic rock or the ultramafic rock from which the metal component has been extracted into the leaching fluid by the method for leaching the rock metal component according to claim 1.

7. The method according to claim 6, wherein the storage liquid is alkaline.

8. The method according to claim 6, wherein the storage liquid contains a chelating agent.

9. The method according to claim 8, wherein the chelating agent contained in the storage liquid is composed of a biodegradable chelating agent or a thermally decomposable chelating agent.

10. A method for fixing carbon dioxide, wherein the leaching fluid into which the metal component has been extracted by the method for leaching the rock metal components according to claim 1 is recovered, and the metal component contained in the recovered leaching fluid is chemically reacted with carbon dioxide to produce a carbonate mineral.
